(19) United States
(12) Patent Application Publication
(10) Pub. No.: US 2006/0098126 A1
(43) Pub. Date: May 11, 2006

(54) Plasma display panel assembly and method of fabricating the same

(75) Inventor: Jung-Suk Song, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/251,782

(22) Filed: Oct. 18, 2005

(30) Foreign Application Priority Data
Oct. 19, 2004 (KR) 10-2004-0083502

(51) Int. Cl. H04N 5/64

(52) U.S. Cl. 348/836

(57) ABSTRACT

A plasma display panel includes a front panel and a rear panel coupled with each other, and an exhaust tube is arranged on the plasma display panel. The plasma display panel and the exhaust tube satisfy L/T≦2, L is a length of the exhaust tube, and T is a thickness of the plasma display panel.

### CROSS-REFERENCE TO RELATED PATENT APPLICATIONS

This application claims priority to and the benefit of Korean Patent Application No. 10-2004-0083502, filed on Oct. 19, 2004, which is hereby incorporated by reference for all purposes as if fully set forth herein.

### BACKGROUND OF THE INVENTION

1. Field of the Invention

The present invention relates to a plasma display panel assembly, and more particularly, to an exhaust tube of a plasma display panel assembly.

2. Discussion of the Related Art

Generally, a plasma display panel assembly is a flat panel display device, in which discharge electrodes are formed on facing substrates. A discharge gas is injected into a discharge space, and a voltage is applied to the discharge electrodes to generate a discharge, thereby generating ultraviolet rays, which excite a phosphor layer to emit light for displaying images.

The plasma display assembly may be formed by coupling a front panel and a rear panel to each other, coupling a chassis base with the panel assembly, mounting a circuit board on the chassis base so that electric signals may be transmitted between the chassis base and the panel assembly, and installing the assembly in a case after performing predetermined tests.

There have been many ways to reduce noise generated when driving the plasma display panel assembly. For example, structures of barrier ribs formed in the panel assembly may be changed, or a noise absorbent may be included to absorb vibrations of the panel assembly and the chassis base.

Referring to FIG. 1, in a conventional barrier rib 100, a stripe-shaped main barrier rib 101 is formed in a display area Da of the panel assembly to define discharge cells. A dummy barrier rib 102 is formed in a non-display area NDa, which is formed outside of the display area Da and is coupled with external terminals. The dummy barrier rib 102 extends from the main barrier rib 101, and it includes a plurality of arcs that are repeatedly connected to each other while overlapping each other. Due to the dummy barrier rib 102, the main barrier rib 101 may be fixed on its original position when the barrier ribs are baked.

However, a part of the upper portion of the dummy barrier rib 102 may slant during the extraction of the barrier rib generated during the baking process. Accordingly, when the rear panel is sealed with the front panel, a gap may be generated between the front panel and the dummy barrier rib 102, which may cause vibration and noise when driving the panel. Additionally, since the dummy barrier rib 102 is not synchronic in up-and-down and left-to-right directions, the extraction force may not be applied uniformly to the dummy barrier rib 102. Thus, a part of the barrier rib may be bent. Consequently, noise may be generated in the panel assembly.

In order to prevent noise, silicon or soft plastic may be used as a vibration absorbent to prevent the panel assembly from vibrating, however, the amount of noise that may be reduced by using the vibration absorbent is limited.

Accordingly, the structure may be changed or another kind of vibration absorbent may be used to remove the noise generated in the panel assembly. However, the noise generated in the panel assembly may not be completely removed by the other conventional methods.

Recently, a cause of the noise has been considered to be related to an exhaust tube that is installed to perform a vacuum exhaustion process. Actually, noise levels measured on the front and rear surfaces of the panel assembly differ from each other. More noise is generated on the portion where the exhaust tube is installed since the exhaust tube echoes the noise generated in the panel assembly. Accordingly, an optimal design of the exhaust tube and the panel assembly is desired.

### SUMMARY OF THE INVENTION

The present invention provides a plasma display panel assembly having an exhaust tube installed on a panel assembly, and a panel assembly of optimized design, and a method of fabricating the same.

Additional features of the invention will be set forth in the description which follows, and in part will be apparent from the description, or may be learned by practice of the invention.

The present invention discloses a plasma display panel including a front panel and a rear panel coupled with each other, and an exhaust tube arranged on one of the front panel and the rear panel. L is a length of the exhaust tube, T is a thickness of the plasma display panel, and L/T≦2.

The present invention also discloses a plasma display panel assembly including a plasma display panel including an exhaust tube and a front panel and a rear panel sealed together by a frit glass, a chassis base arranged on a rear portion of the plasma display panel to support the plasma display panel, a driving circuit unit coupled with the chassis base and transmitting electric signals to the plasma display panel, and a case housing the plasma display panel, the chassis base, and the driving circuit unit. L is a length of the exhaust tube, T is a thickness of the plasma display panel, and L/T≦2.

The present invention also discloses a method of fabricating a plasma display panel assembly including forming a plasma display panel including a front panel and a rear panel coupled with each other, forming an exhaust tube on the plasma display panel for exhausting a discharge space, sealing the front and rear panels using a frit glass, and exhausting the discharge space. L is a length of the exhaust tube, T is a thickness of the plasma display panel, and L/T≦2.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of a conventional barrier rib.

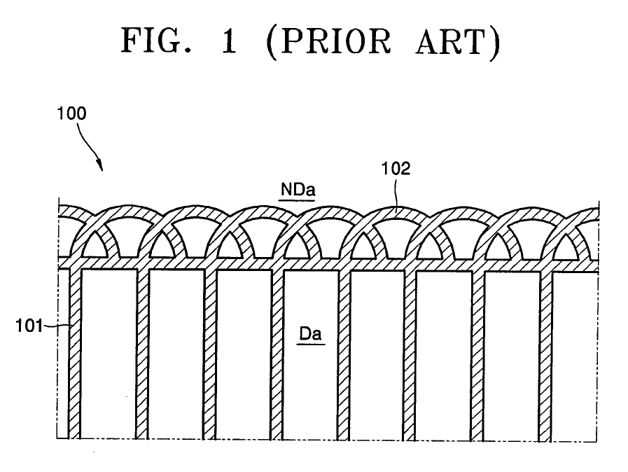

FIG. 2 is an exploded perspective view of a part of a plasma display panel according to an exemplary embodiment of the present invention.

FIG. 3 is an exploded perspective view of a plasma display panel assembly including the plasma display panel of FIG. 2.

FIG. 4 is an exploded perspective view of an expanded portion of an exhaust tube according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

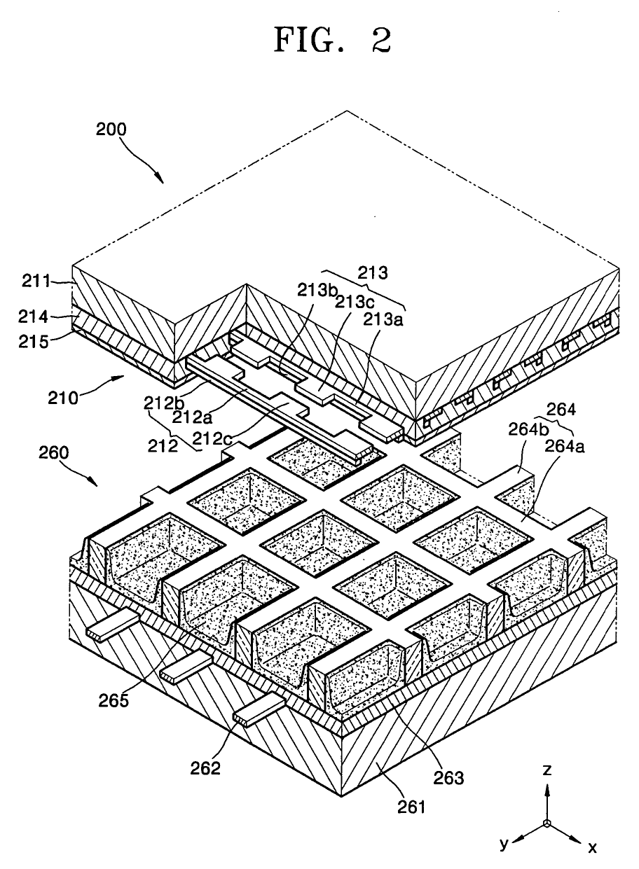

FIG. 2 shows a part of a plasma display panel 200 according to an exemplary embodiment of the present invention.

Referring to FIG. 2, the plasma display panel 200 includes a front panel 210 and a rear panel 260 arranged substantially parallel to each other. A frit glass is applied on edges of facing surfaces of the front and rear panels 210 and 260 to form a sealed inner space.

The front panel 210 includes a front substrate 211, which may be formed of a transparent material such as, for example, soda lime glass. X and Y electrodes 212 and 213 are arranged on the front substrate 211 in an X direction of the panel 200. The X and Y electrodes 212 and 213 are alternately arranged in a Y direction of the panel 200.

The X electrode 212 includes a first transparent electrode line 212a arranged on an inner surface of the front substrate 211 and a first bus electrode line 212b arranged along an edge of the first transparent electrode line 212a. A first protrusion electrode 212c extends from the inner wall of the first transparent electrode line 212a toward the Y electrode 213. The first protrusion electrode 212c may be integrally formed with the first transparent electrode line 212a.

The Y electrode 213 includes a second transparent electrode line 213a arranged on an inner surface of the front substrate 211 and a second bus electrode line 213b arranged along an edge of the second transparent electrode line 213a. A second protrusion electrode 213c extends from the inner wall of the second transparent electrode line 213a toward the X electrode 212. The second protrusion electrode 213c may be integrally formed with the second transparent electrode line 213a.

The first transparent electrode line 212a and the first protrusion electrode 212c, and the second transparent electrode line 213a and the second protrusion electrode 213c, may be formed of a transparent conductive layer such as, for example, an indium tin oxide (ITO) layer, for improving an aperture rate of the front substrate 211. The first and second bus electrode lines 212b and 213b may be formed of a highly conductive metallic material such as, for example, Ag paste or Cr—Cu—Cr alloy, in order to reduce line resistances of the first and second transparent electrode lines 212a and 213a and improve electric conductivity.

A front dielectric layer 214 covers the X and Y electrodes 212 and 213. The front dielectric layer 214 may be selectively formed on portions of the front substrate 211 where the X and Y electrodes 212 and 213 are arranged, or it may be applied on the entire lower surface of the front substrate 211. A protective layer 215, such as an MgO layer, covers the front dielectric layer 214 in order to prevent the front dielectric layer 214 from damage and to increase secondary electron emission.

The rear panel 260 includes a rear substrate 261. Address electrodes 262 are arranged on the rear substrate 261 in a direction crossing the X and Y electrodes 212 and 213, and a rear dielectric layer 263 covers the address electrodes 262.

Barrier ribs 264, which define discharge cells with the front and rear panels 210 and 260, are arranged between the front and rear panels 210 and 260. The barrier ribs 264 include a first barrier rib 264a, which is arranged in a direction crossing the address electrodes 262, and a second barrier rib 264b, which is arranged parallel to the address electrodes 262. The first barrier rib 264a extends integrally from inner walls of a pair of adjacent second barrier ribs 264b toward each other, and the first and second barrier ribs 264a and 264b are coupled with each other to form a matrix shape.

Additionally, the barrier ribs 264 are coupled with a dummy barrier rib (not shown) arranged in a non-display area of the plasma display panel 200. The dummy barrier rib may be formed to be synchronic in the up-and-down and left-to-right directions in order to prevent the barrier ribs 264 from bending.

A discharge gas, such as Ne—Xe or He—Xe, may be injected in the discharge cells defined by the barrier ribs 264 and the front and rear panels 210 and 260. Additionally, red, green, and blue phosphor layers 265, which are excited by ultraviolet rays generated from the discharge gas, are applied in the discharge cells. The red, green, and blue phosphor layers may be applied on any region in the discharge cells.

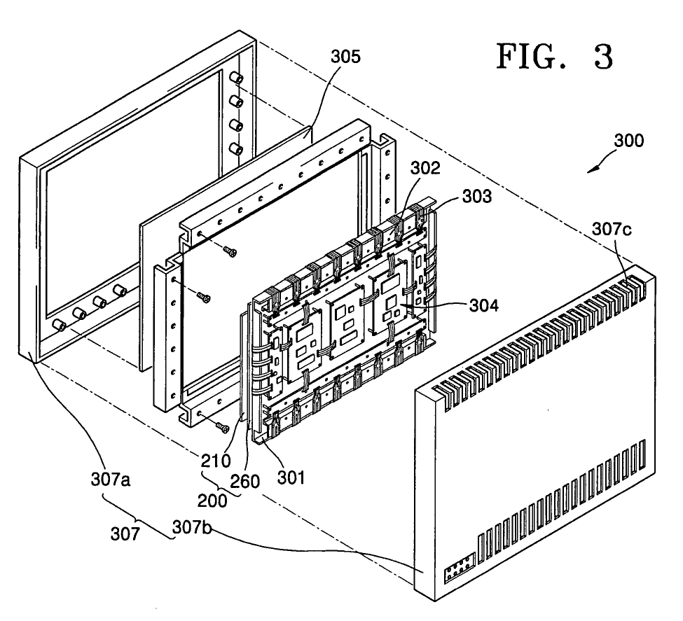

FIG. 3 shows a plasma display panel assembly 300 including the plasma display panel 200 of FIG. 2.

Referring to FIG. 3, the plasma display panel assembly 300 includes the plasma display panel 200, a chassis base 301 coupled with the plasma display panel 200, a driving circuit unit 304 coupled with the chassis base 301, a filter assembly 305 arranged on a front portion of the plasma display panel 200, and a case 307 housing the above elements.

The chassis base 301 supports the plasma display panel 200 and disperses heat generated by the plasma display panel 200 in order to dissipate the heat. Therefore, the chassis base 301 may be formed of an aluminum alloy that has high thermal conductivity and rigidity.

Chassis reinforcing members 302 may be further formed on upper and lower ends of the chassis base 301. A flexible printed cable 303 may couple the plasma display panel 200 with the driving circuit unit 304.

The filter assembly 305 is arranged on the front portion of the plasma display panel 200. The filter assembly 305 blocks electromagnetic waves, ultraviolet rays, neon emission lights, or reflection of external lights.

The case 307 includes a front cabinet 307a arranged on the front portion of the filter assembly 305, and a rear cover 307b arranged on a rear portion of the chassis base 301, to which the driving circuit unit 304 is attached. A plurality of vent holes 307c are formed on upper and lower ends of the rear cover 307b.

Here, an exhaust tube, which acts as a path for exhausting gas from the inner sealed space of the plasma display panel 200 during the vacuum exhaustion process, is arranged on a side of the plasma display panel 200, and a length of the exhaust tube is determined in relation to a thickness of the plasma display panel 200.

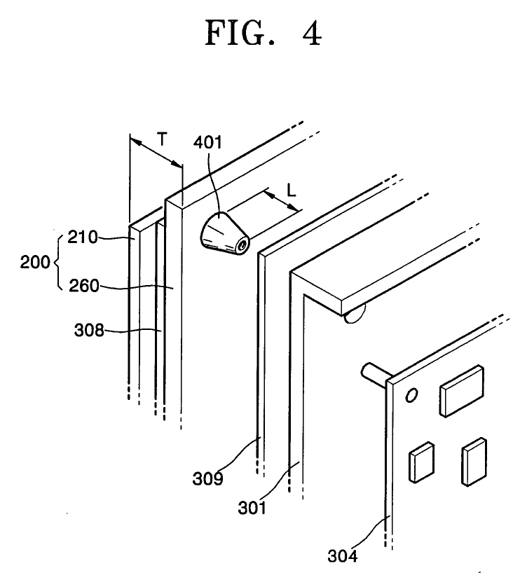

FIG. 4 shows the portion of the plasma display panel assembly where the exhaust tube 401 is installed.

Here, the same reference numerals as those of the previous drawings denote the same elements performing the same functions.

Referring to FIG. 4, a frit glass 308 is applied on edges of the surfaces of the front and rear panels 210 and 260 facing each other. Additionally, the chassis base 301 is coupled with the rear portion of the rear panel 260 using an adhesive member 309. Here, the exhaust tube 401 is arranged on the rear surface of the rear panel 260.

That is, the processes of forming the plasma display panel 200 includes fabricating the front panel 210, fabricating the rear panel 260, and coupling the front and rear panels 210 and 260 with each other.

In order to fabricate the front panel 210, the X and Y electrodes 212 and 213 are formed on the front substrate 211, the transparent front dielectric layer 214 is formed to cover the X and Y electrodes 212 and 213, and the protective layer 215 is formed on the dielectric layer 214.

In order to fabricate the rear panel 260, the address electrodes 262 are formed on the rear substrate 261, the rear dielectric layer 263 is formed to cover the address electrodes 262, the barrier ribs 264 are formed to define the discharge spaces, and the red, green, and blue phosphor layers 265 are applied inside of the barrier ribs 264.

The first and second panels 210 and 260 are sealed by applying the frit glass 308 along the edges of the surfaces thereof facing each other, air is exhausted from the sealed space, discharge gas is injected into the space, and an aging process is performed.

The exhaust tube 401 is arranged on a side of the plasma display panel 200 in order to exhaust air or impure gas remaining in the space between the front and rear panels 210 and 260 Thus, the air or impure gas between the front and rear panels 210 and 260 may be exhausted through the exhaust tube 401.

The exhaust tube 401 is arranged on a corner of the rear panel 260. The exhaust tube 401 penetrates the rear panel 260 and protrudes from the rear surface of the rear panel 260 toward the chassis base 301 to a predetermined length L. A cross-section of the exhaust tube 401 decreases from the surface of the rear panel 260 to the chassis base 301, and in the present embodiment, the exhaust tube 401 is formed in a cone-like shape.

Here, when the length of the exhaust tube 401, that is, the length of protrusion from the surface of the rear panel 260 is L, and a thickness of the plasma display panel 200 is T, L and T should satisfy following expression.
L/T≦2 (1)

If L/T exceeds 2, the length of the exhaust tube 401 is too long and the exhaust tube echoes noise generated in the inner space of the panel assembly 200.

Table 1 shows the results when measuring noise according to the change of length of the exhaust tube.

TABLE 1

| | Length of exhaust | Noise at front | Noise at rear |
|---|---|---|---|
| | tube | portion | portion |
| Comparative | 15 mm | 27 dB | 29 dB |
| example | | | |
| Embodiment 1 | 10 mm | 25 dB | 27 dB |
| Embodiment 2 | 5 mm | 23 dB | 25 dB |

Here, the comparative example was a conventional plasma display panel assembly, the thickness of the plasma display panel was 6 mm and the length of the exhaust tube was 15 mm. Embodiment 1 was an example of a plasma display panel assembly according to an exemplary embodiment of the present invention, where the thickness of the plasma display panel was 6 mm and the length of the exhaust tube was 10 mm. Embodiment 2 was another example of a plasma display panel assembly according to an exemplary embodiment of the present invention, where the thickness of the plasma display panel was 6 mm and the length of the exhaust tube was 5 mm.

Referring to Table 1, the noise measured at the front portion of the plasma display panel was 27 dB, and the noise measured at the rear portion was 29 dB in the comparative example. On the contrary, the noise measured at the front portion of the plasma display panel was 25 dB, and the noise measured at the rear portion was 27 dB in the first embodiment. Additionally, the noise on the front portion was 23 dB, and the noise on the rear portion was 25 dB in the second embodiment.

That is, in plasma display panels having the same thickness, when the length of the exhaust tube was reduced from 15 mm to 5 mm in 5 mm increments, the noise at the front portion of the plasma display panel was reduced by 2˜4 dB, and the noise at the rear portion of the plasma display panel was also reduced 2˜4 dB.

Forming an exhaust tube such that a ratio of the length of the tube to the thickness of the plasma display panel is within a certain range may provide the following effects.

Noise generated in the plasma display panel when driving the plasma display panel may be minimized.

Additionally, since the length of the exhaust tube is reduced, the possibility of damaging the tube during panel assembly may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a front panel and a rear panel coupled with each other; and
an exhaust tube arranged on the front panel or the rear panel,
wherein L/T≦2,
wherein L is a length of the exhaust tube and T is a thickness of the plasma display panel.

2. The plasma display panel of claim 1, wherein the exhaust tube protrudes from a surface of the rear panel.

3. The plasma display panel of claim 2, wherein the exhaust tube penetrates the rear panel.

4. The plasma display panel of claim 2, wherein a cross-sectional area of the exhaust tube gradually decreases in a direction away from the rear panel.

5. The plasma display panel of claim 4, wherein the exhaust tube is formed in a cone-like shape.

6. A plasma display panel assembly, comprising:
a plasma display panel comprising a front panel and a rear panel sealed together by a frit glass, and an exhaust tube;
a chassis base arranged at a rear portion of the plasma display panel to support the plasma display panel;
a driving circuit unit coupled with the chassis base and transmitting electric signals to the plasma display panel; and
a case housing the plasma display panel, the chassis base, and the driving circuit unit,
wherein L/T≦2, and
wherein L is a length of the exhaust tube, and T is a thickness of the plasma display panel.

7. The assembly of claim 6, wherein the exhaust tube protrudes from a surface of the rear panel towards the chassis base.

8. The assembly of claim 7, wherein the exhaust tube penetrates the rear panel.

9. The assembly of claim 7, wherein a cross-sectional area of the exhaust tube gradually decreases in a direction from the plasma display panel toward the chassis base.

10. The assembly of claim 9, wherein the exhaust tube is formed in a cone-like shape.

11. A method of fabricating a plasma display panel assembly, comprising:
forming a plasma display panel including a front panel and a rear panel coupled with each other;
forming an exhaust tube on the plasma display panel for exhausting a discharge space;
sealing the front panel and the rear panel together using a frit glass; and
exhausting the discharge space,
wherein L/T≦2, and
wherein L is a length of the exhaust tube and T is a thickness of the plasma display panel.
